(19) United States
(12) Patent Application Publication
(10) Pub. No.: US 2023/0324671 A1
(43) Pub. Date: Oct. 12, 2023

(54) OPTICAL SYSTEMS WITH TILTABLE FILTERS

(71) Applicant: SEMICONDUCTOR COMPONENTS INDUSTRIES, LLC, Phoenix, AZ (US)

(72) Inventor: David Wayne JASINSKI, Petaluma, CA (US)

(73) Assignee: SEMICONDUCTOR COMPONENTS INDUSTRIES, LLC, Phoenix, AZ (US)

(21) Appl. No.: 17/658,153

(22) Filed: Apr. 6, 2022

(51) Int. Cl. G02B 26/00; G02B 5/28

(52) U.S. Cl. CPC G02B 26/007; G01J 2003/1243; G02B 5/28

(57) ABSTRACT

Imaging systems employing active illumination such as in-cabin monitoring or LiDAR systems may include a laser or LED source and an image sensor that is triggered by light reflecting off a target scene. The light has a spectral response that drifts as a function of temperature. To help compensate for such drifting in the spectral response of the light, a tiltable bandpass filter may be disposed over the image sensor. The bandpass filter is tilted or rotated using a filter tilting device. The filter tilting device may tilt or rotate the bandpass filter by an amount that causes a shift in the passband of the bandpass filter so that the shifted passband is aligned with the spectral response of the laser light across different ambient temperatures. Aligning the filter passband to the peak spectral response of the light source can help improve rejection of unwanted illumination from extraneous light sources.

### BACKGROUND

This relates generally to imaging systems such as LiDAR (light detection and ranging) and in-cabin monitoring imaging systems which employ active illumination.

These imaging systems illuminate a target with a light source. LiDAR systems typically consist of coherent laser pulse light source and time-of-flight circuitry for measuring the return time of reflections off the target to determine a distance to the target and light intensity to generate three-dimensional images of a scene. The time-of-flight circuitry may determine the flight time of laser pulses (e.g., having been reflected by the target), and thereby determine the distance to the target. In direct time-of-flight LiDAR systems, this distance is determined for each pixel in an array of single-photon avalanche diode (SPAD) pixels that form an image sensor. In-cabin monitoring typically uses an area array to form a two-dimensional image of the illuminated scene.

The light emitted in these imaging systems for illuminating the target typically has a spectral distribution centered around a given wavelength at nominal ambient temperature. Conventionally, these systems often include a bandpass filter disposed above the image sensor. The bandpass filter has a fixed passband that is also centered around the given wavelength so that only light associated with the target illuminating light source is passed through to the image sensor.

In practice, however, the spectral distribution of both laser and, particularly, light-emitting diode (LED) light sources can drift as a function of ambient temperature. For instance, as the ambient temperature rises above the nominal temperature, the spectral distribution of the light source might shift to a longer wavelength that is outside of the fixed passband of the bandpass filter. As a result, the spectral distribution of the light source will no longer be aligned with the passband of the filter at elevated operating temperatures.

It is within this context that the embodiments herein arise.

### BRIEF DESCRIPTION OF THE DRAWINGS

FIG. 1 is a schematic diagram of an illustrative system that includes a LiDAR imaging system in accordance with some embodiments.

FIG. 2 is a diagram of an illustrative vehicle having a LiDAR imaging system in accordance with some embodiments.

FIG. 3 is a diagram illustrating the spectral response of a light source at different ambient temperatures in accordance with some embodiments.

FIG. 4 is a cross-sectional side view of an illustrative imaging assembly having a tiltable bandpass filter in a tilted configuration in accordance with some embodiments.

FIG. 5 is a cross-sectional side view of an illustrative imaging assembly having a tiltable bandpass filter in a non-tilted configuration in accordance with some embodiments.

FIG. 6A is a cross-sectional side view of illustrative bimetallic strips having different coefficients of thermal expansion in accordance with some embodiments.

FIG. 6B shows how the bimetallic strips of FIG. 6A can exhibit a mechanical deflection in response to changes in temperature in accordance with some embodiments.

FIG. 7 is a side view showing how an illustrative helically wrapped bimetallic strip can be used to rotate a screw in accordance with some embodiments.

FIG. 8 is a perspective view showing how an illustrative helically wrapped bimetallic strip can be used to directly rotate a filter in accordance with some embodiments.

FIG. 9 is a perspective view showing how an illustrative helically wrapped bimetallic strip can be used to rotate a filter via a gear train in accordance with some embodiments.

FIG. 10 is block diagram of an illustrative mechanical actuator controlled by a temperature sensor in accordance with some embodiments.

### DETAILED DESCRIPTION

Embodiments of the present invention relate to LiDAR and in-cabin monitoring systems that use active illumination.

Some imaging systems include image sensors that sense light by converting impinging photons into electrons or holes that are integrated (collected) in pixel photodiodes within a sensor array. After completion of an integration cycle, collected charge is converted into a voltage, which is supplied to the output terminals of the sensor. In complementary metal-oxide semiconductor (CMOS) image sensors, the charge to voltage conversion is accomplished directly in the pixels themselves and the analog pixel voltage is transferred to the output terminals through various pixel addressing and scanning schemes. The analog pixel voltage can also be later converted on-chip to a digital equivalent and processed in various ways in the digital domain.

In light detection and ranging (LiDAR) devices, on the other hand, the photon detection principle is different. LiDAR devices may include a light source, such as a laser or a light-emitting diode (LED), that emits light toward a target object or scene. A light sensing diode such as a single-photon avalanche diode (SPAD) in the LiDAR devices may be biased slightly above its breakdown point and when an incident photon from the laser (e.g., light that has reflected off of the target object/scene) generates an electron or hole, this carrier initiates an avalanche breakdown with additional carriers being generated. The avalanche multiplication may produce a current signal that can be easily detected by readout circuitry associated with the SPAD. The avalanche process needs to be stopped (quenched) by lowering the diode bias below its breakdown point.

In LiDAR devices, multiple SPAD pixels may be used to measure photon time-of-flight (ToF) from a synchronized light source to a scene object point and back to the sensor, which can be used to obtain a 3-dimensional image of the scene. This method requires time-to-digital conversion circuitry to determine an amount of time that has elapsed since the laser light has been emitted and thereby determine a distance to the target object.

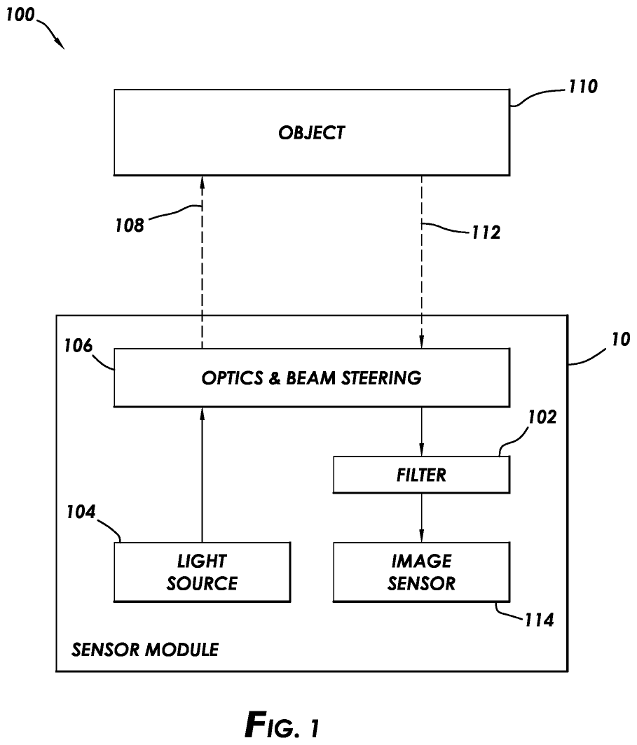

FIG. 1 is a schematic diagram of an illustrative system 100 that includes a LiDAR imaging system. System 100 of FIG. 1 may be an automotive system (e.g., an active braking system or other vehicle safety system), a surveillance system, a medical imaging system, a general machine vision system, an eye tracking system, a driver monitoring system, or any other desired type of system. System 100 includes a LiDAR-based sensor module 10. Sensor module 10 may be used to capture images of a scene and measure distances to objects (also referred to as targets or obstacles) in the scene.

As an example, in a vehicle safety system, information from the LiDAR-based sensor module 10 may be used by the vehicle safety system to determine environmental conditions surrounding the vehicle. As examples, vehicle safety systems may include systems such as a parking assistance system, an automatic or semi-automatic cruise control system, an auto-braking system, a collision avoidance system, a lane keeping system (sometimes referred to as a lane-drift avoidance system), a pedestrian detection system, etc. In at least some instances, a LiDAR module may form part of a semi-autonomous or autonomous self-driving vehicle.

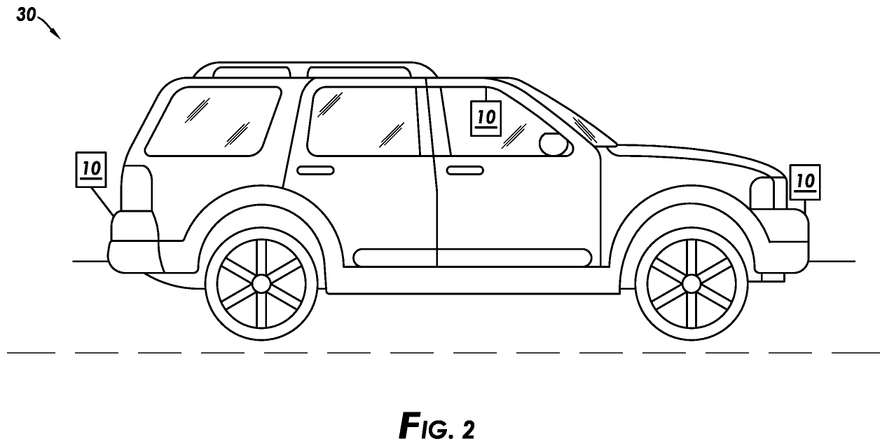

An illustrative example of a vehicle such as an automobile 30 is shown in FIG. 2. As shown in the illustrative example of FIG. 2, automobile 30 may include one or more sensor modules 10. The sensor modules 10 may form at least part of a vehicular safety system 100 as discussed above. Sensor modules 10 may be devices or systems with dedicated image capture and/or image processing functions. If desired, a sensor module 10 may perform some or all of the image processing functions associated with a given driver assist operation. A dedicated driver assist processor may receive signals from sensor module 10. While various sensor modules 10 can be placed at different locations within automobile 30, the driver assist processor can be disposed at a central location within automobile 30 (e.g., near the engine bay).

In another suitable example, a sensor module 10 may perform only some or none of the image processing operations associated with a given driver assist function. For example, sensor module 10 may merely capture images of the environment surrounding the vehicle 30 and transmit the image data to the processor for further processing. Such an arrangement may be used for vehicle safety system functions that require large amounts of processing power and memory (e.g., full-frame buffering and processing of captured images).

In the illustrative example of FIG. 2, a first sensor module 10 is shown mounted on the front of car 30 (e.g., to capture images of the surroundings in front of the car), and a second sensor module 10 is shown mounted in the interior of car 30 (e.g., to capture images of the driver of the vehicle). If desired, a sensor module 10 may be mounted at the rear end of vehicle 30 (i.e., the end of the vehicle opposite the location at which first imaging system 10 is mounted in FIG. 2). The imaging system at the rear end of the vehicle may capture images of the surroundings behind the vehicle. These examples are merely illustrative. One or more sensor modules 10 may be mounted on or within a vehicle 30 at any desired location(s).

Referring back to FIG. 2, sensor module 10 may include a light source 104 (e.g., laser, light-emitting diode, or other light sources) that emits light 108 to illuminate an external object 110. Light source 104 may emit light 108 at any desired wavelength (e.g., infrared light, visible light, ultraviolet light, etc.). Optics and beam-steering equipment 106 may be used to direct the light beam from laser 104 towards external object 110. Light 108 may illuminate external object 110 and return to sensor module 10 as a reflection 112. One or more lenses in optics and beam-steering 106 may focus the reflected light 112 onto an image sensor 114.

As an example, an array of SPAD pixels (sometimes referred to as a SPAD array) may be formed on an optical sensor such as image sensor die 114. In single-photon avalanche diode (SPAD) devices, the light sensing diode is biased above its breakdown point. When an incident photon generates an electron or hole, this carrier initiates an avalanche breakdown with additional carriers being generated. The avalanche multiplication may produce a current signal that can be easily detected by readout circuitry associated with the SPAD. The avalanche process can be stopped (or quenched) by lowering the diode bias below its breakdown point. Each SPAD may therefore include a passive and/or active quenching circuit for halting the avalanche. The SPAD pixels may be used to measure photon time-of-flight (ToF) from a synchronized light source (e.g., laser 104) to a scene object point and back to the sensor, which can be used to obtain a 3-dimensional image of the scene.

To help isolate the reflected light 112 associated with light source 104 while rejecting unwanted ambient light from other surrounding light sources, sensor module 10 may be provided with a filter such as a bandpass filter 102 configured to filter light arriving at image sensor 114. Bandpass filter 102 may, as an example, be implemented as an interference filter having multiple layers of dielectric material with different indices of refraction. This is merely illustrative. If desired, filter 102 may be a low pass filter, a high pass filter, a band rejection filter, or other types of optical filters. Embodiments in which light source 104 is an infrared emitter and bandpass filter 102 is an infrared bandpass filter configured to pass infrared (or near-IR) light are sometimes described herein as an example.

FIG. 3 is a diagram illustrating the spectral response of light source 104 at different ambient temperatures. Curve 120 may represent the spectral distribution of light source 104 at a nominal ambient temperature of 30° C. (as an example). This is merely illustrative. In general, the nominal temperature can be any temperature reading. Curve 120 may be centered about wavelength λ₁. Filter 102 may exhibit a passband 130 that is also centered about wavelength λ₁ when the ambient temperature is at the nominal level. Configured in this way, any light emitted from light source 104 and reflecting back from an external object or target can be passed through filter 102 while rejecting other extraneous wavelengths.

In practice, however, the spectral distribution of light source 104 can drift as a function of temperature. For example, the spectral output of light source 104 can shift to longer wavelengths at higher operating temperatures, whereas the spectral output of light source 104 can shift to shorter wavelengths at lower operating temperatures. In the example of FIG. 3, curve 122 may represent the spectral distribution of light source 104 at an elevated temperature that is more than 50° C. greater than the nominal temperature. Curve 122 corresponding to the higher temperature has drifted to the right and is centered about a longer wavelength λ₂ that is beyond (outside) of the original filter passband 130. It would therefore be desirable to provide an improved filtering mechanism having a passband that can accommodate the spectral response of light source 104 at different temperatures. One conventional way of accommodating such varying spectral responses is to employ a fixed filter having a much wider passband (e.g., a filter response that is much wider than the narrowband response 130 shown in FIG. 3). A filter with a wider passband, however, also passes through more extraneous ambient light, which can degrade the accuracy of the imaging system.

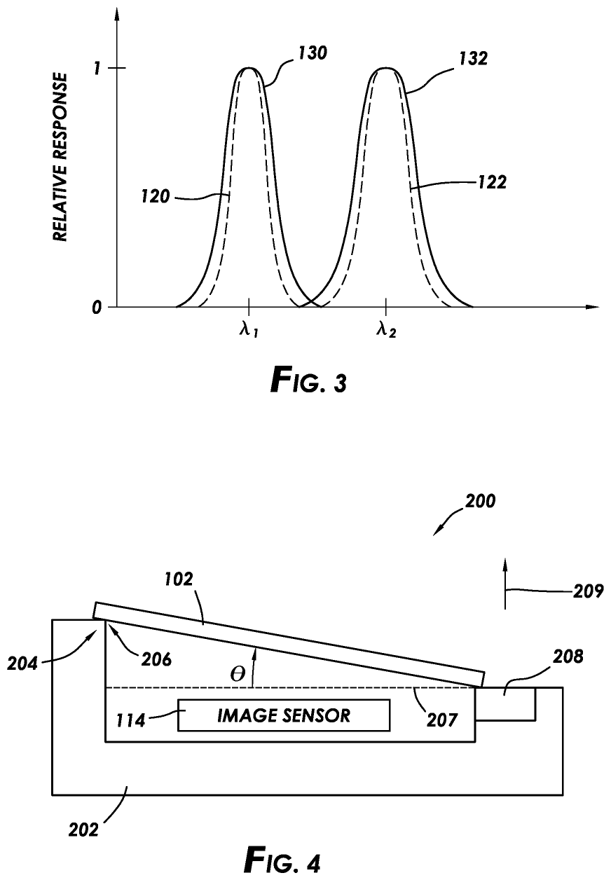

In accordance with an embodiment, filter 102 may be tilted at an angle with respect to image sensor 114 to help compensate for any drifting in the spectral output of light source 104 as temperature varies. The spectral transmittance of filter 102 changes depending on the angle of incidence of incoming light. Thus, by adjusting the angle of tilt of filter 102, the peak spectral passband of filter 102 can be automatically shifted to align with the drifting peak spectral output of light source 104. FIG. 4 is a cross-sectional side view of an image sensor assembly such as image sensor assembly 200. As shown in FIG. 4, image sensor assembly 200 may include an image sensor assembly housing 202, an image sensor 114 disposed within housing 202, and a filter 102 disposed over image sensor 114. As described above in connection with FIGS. 1 and 3, filter 102 may be a bandpass filter (e.g., an interference filter) having a narrow passband that follows the spectral response of light source 104 as temperature varies.

Filter 102 may have a first end attached to a portion 204 of assembly housing 202. Filter 102 can tilt about point (hinge) 206 in housing portion 204. Filter 102 may have a second end attached to portion 208 of assembly housing 202. Portion 208 may be an adjustable mechanism configured to push the second end of filter 102 upwards in direction 209. Portion 208 may be a filtering adjustment device such as a filter tilting device. FIG. 4 shows filter tilting device 208 in an unactuated state. In this unactuated state, filter 102 may be tilted at an angle θ measured from a plane 207 that is parallel to an imaging surface of sensor 114. Angle θ may be at its maximum value when device 208 is fully unactuated. Angle θ may have a maximum value of less than 20°, less than 16°, 10-20°, less than 30°, 15-16°, 14-17°, 13-18°, greater than 10°, greater than 15°, or other suitable values. In this tilted configuration, filter 102 may exhibit a passband at shorter wavelengths (see, e.g., passband 130 in FIG. 3).

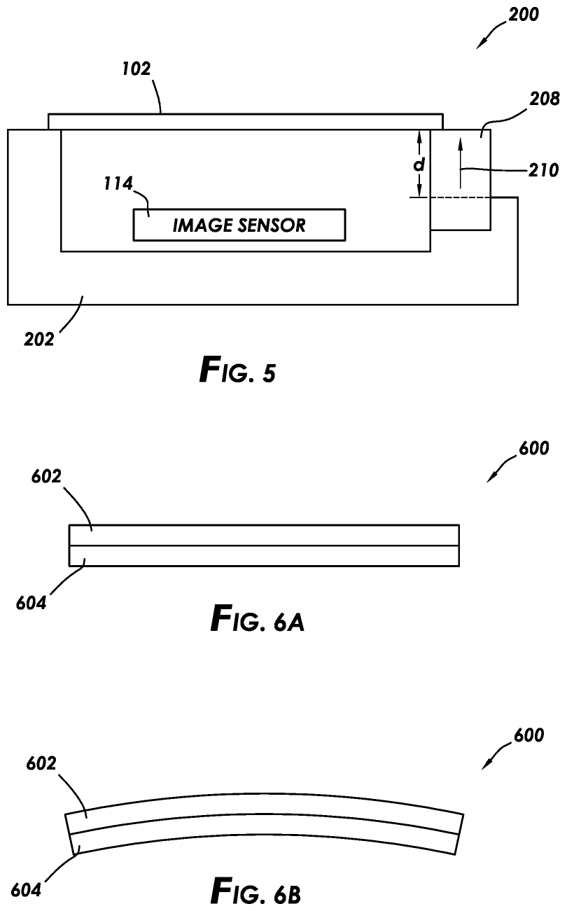

FIG. 5 shows filter tilting device 208 in an actuated state. As shown in FIG. 5, device 208 can push (deflect) filter 102 in the direction of arrow 210 by a distance d so that filter 102 is no longer tilted relative to image sensor 114 (i.e., filter 102 and image sensor 114 have upper and lower surfaces that are now parallel). Angle θ is now zero. In this untilted or non-tilted configuration, filter 102 may exhibit a passband center at longer wavelengths (see, e.g., passband 132 in FIG. 3). Filter 102 operated in this way can therefore sometimes be referred to as a tilting (tiltable) filter, a rotating (rotatable) filter, an adjustable tilt filter, etc. In other words, the amount of tilt of filter 102 with respect to the imaging plane of image sensor 114 can be controlled to tune the effective passband of filter 102 to help compensate for any spectral response drift in the light source across different temperatures and thus improve rejection of undesired wavelengths. The amount of passband shift from λ₁ (in the unactuated/tilted filter state) to λ₂ (in the actuated/non-tilted filter state) can be equal to at least 30 nm (nanometers), at least 40 nm, at least 50 nm, 30-50 nm, 20-60 nm, 10-70 nm, more than 80 nm, more than 90 nm, more than 100 nm, etc. The difference between λ₁ and λ₂ may also be a function of the maximum deflection distance d between the unactuated and the actuated state of filter tilting device 208.

Configured and operated in this way, the peak spectral passband of filter 102 can automatically adjust to the shift in peak spectral output of the active illumination light source 104. This can help produce better rejection of unwanted illumination caused by other light sources unrelated to the illumination of the light source 104. Although a close tracking of the filter passband with the peak spectral output of the light source would be ideal, even an approximate tracking would enable a significant rejection of unwanted light. In automotive driver monitoring systems, this can help eliminate deleterious effects of bright daylight illumination or glare coming in from windows, which can introduce shadow and shadow motion across the subject/target being monitored or can adversely affect eye and gaze tracking.

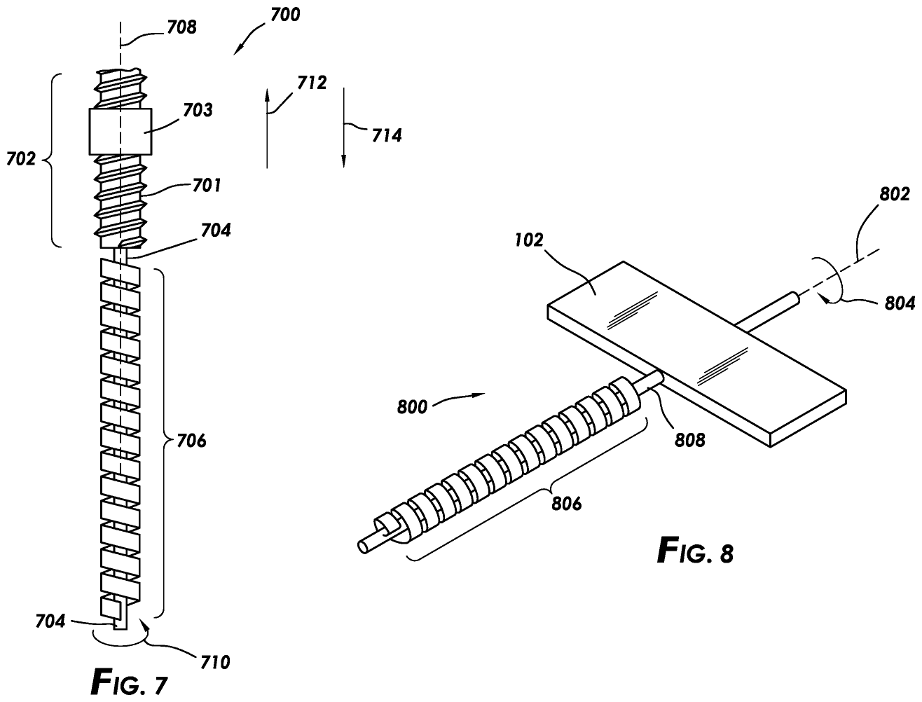

The example of FIGS. 5 and 6 where bandpass filter 102 appears to sit on top of assembly housing 202 is merely illustrative. Assembly housing 202 may optionally have portions that laterally surrounds filter 102 or extends over filter 102. Any portion of assembly housing 202 extending over filter 102 may be transparent or at least partially transparent to light of desired wavelengths. As such, filter 102 is sometimes referred to as being disposed within assembly housing 202.

Filter tilting device 108 may employ any suitable mechanism for moving the second end of filter 102. In one embodiment, filter tilting device 108 may include a strip 600 having multiple layers of metal with different coefficients of thermal expansion (see, e.g., FIGS. 6A and 6B). As shown in FIG. 6A, strip 600 may include a first metal layer 602 disposed on a second metal layer 604. First metal layer 602 may have a first thermal expansion coefficient, whereas metal layer 604 may have a second thermal expansion coefficient that is different than the first thermal expansion coefficient. As an example, first metal layer 602 may be a layer of brass having a thermal expansion coefficient equal to 19×10⁻⁶ PC, and second metal layer 604 may be a layer of steel having a thermal expansion coefficient equal to 12×10⁻⁶ PC. As another example, first metal layer 602 may be a layer of copper having a thermal expansion coefficient equal to 17×10⁻⁶ PC, and second metal layer 604 may be a layer of steel having a thermal expansion coefficient equal to 12×10⁻⁶ PC. The two layers of metal may be joined together by riveting, brazing, welding, or other metal joining processes.

Configured in this way, metal layers 602 and 604 will expand at different rates as they are heated (e.g., as temperature rises). The different rates of expansion between metal layers 602 and 604 will cause strip 600 to bend as shown in FIG. 6B. The bending in strip 600 can be used to cause a mechanical deflection of the second end of filter 102 as shown in FIG. 5. The amount of mechanical deflection at each temperature should be designed and calibrated to provide the correct amount of tilt in filter 102, which shifts the corresponding passband to match with the drifting spectral output of the light source. For example, at the nominal ambient temperature, strip 600 may be in the unactuated state (as shown in FIG. 6A), so filter 102 will be in its maximum tilted stated. The passband of filter 102 in this maximum tilted configuration should be centered about the spectral distribution of the light source at the nominal ambient temperature. At an elevated temperature, strip 600 may be in an actuated state (as shown in FIG. 6B), which causes a mechanical deflection that un-tilts filter 102. The passband of filter 102 in this adjusted configuration is now shifted so that it is centered about the spectral distribution of the light source at the elevated ambient temperature. Strip 600 configured and operated in this way to convert a temperature change into a mechanical displacement is sometimes referred to as a bimetallic (bimetal) strip or bimetallic material.

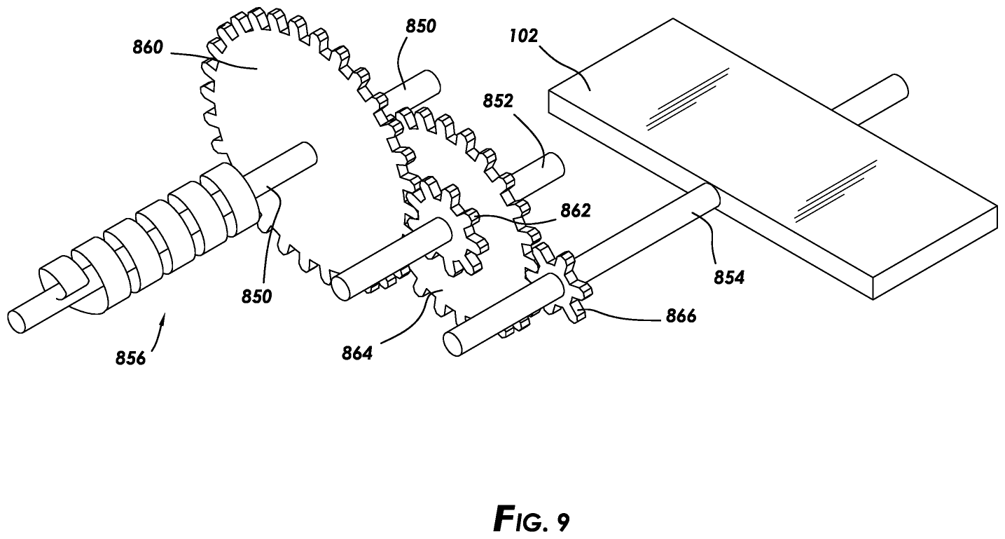

FIG. 7 illustrates another suitable embodiment of a filter tilting device 700 having a bimetallic strip 706 is helically wrapped around and along a rotatable rod 704. Bimetallic strip 706 may be attached to at least one end of rod 704. Strip 706 configured in this way is sometimes referred to as a helical bimetallic (bimetal) coil, a helical bimetallic (bimetal) strip, or a bimetallic thermometer. As the temperature increases, the helical bimetallic strip 706 will wind up, which causes rod 704 to rotate about longitudinal axis 708 in the direction of arrow 710. Rod 704 may be attached to a screw mechanism such as lead screw 702. Lead screw 702 may include a screw shaft 701 having an external helical (spiral) thread and a screw nut 703 having an internal thread that matches the external thread of screw shaft 701. Any rotational movement of rod 704 may cause screw shaft 701 to rotate by the same amount. Assuming screw nut 703, which may be attached to assembly housing 202, is fixed, the rotation of screw shaft 701 will cause the overall lead screw 702 to move up linearly in direction 712.

Filter tilting device 700 of this type can therefore convert temperature changes into linear displacement. Thus, lead screw 702 being rotated by the helical bimetallic strip 706 in this way can be used to push on the second end of filter 102 to un-tilt the bandpass filter when lead screw 702 moves upwards in direction 712 as temperature rises or to tilt the bandpass filter when lead screw 702 moves downwards in direction 714 as temperature falls. The amount of displacement/deflection caused by filter tilting device 700 should be designed and calibrated to provide the proper amount of tilt in filter 102 so that its passband is automatically aligned (centered) to the spectral output of the light source at different ambient temperatures.

The example of FIG. 7 in which the filter tilting device 700 is used to cause a displacement at the second end of filter 102 is merely illustrative. FIG. 8 shows another suitable embodiment where filter tilting device 800 includes a helical bimetallic strip 806 that is joined to a rod 808 that directly tilts filter 102. As shown in FIG. 8, filter 102 may be attached to a rotatable rod 808 so that filter 102 can tilt as rod 808 is rotated. As the ambient temperature increases, helical bimetallic strip 806 (e.g., a bimetal thermometer) may wind up, which causes rod 808 to rotate about rotational axis 802 in the direction of arrow 804. The amount of rotation (tilt) caused by filter tilting device 800 should be designed and calibrated to provide the proper amount of tilt in filter 102 so that its passband is automatically aligned (centered) to the spectral output of the light source at different ambient temperatures.

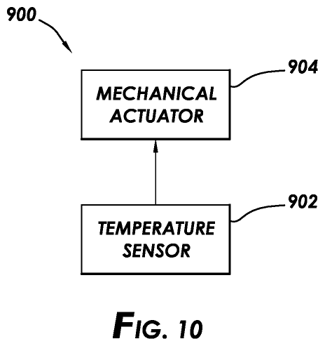

The example of FIG. 8 in which filter tilting device 800 is configured to rotate a rod that is directly attached to filter 102 is merely illustrative. FIG. 9 shows another suitable embodiment where the rotational movement generated by a helical bimetal strip 856 is multiplied (amplified) by a mechanical gear train. As shown in FIG. 9, helical bimetal strip 856 (e.g., a bimetallic thermometer) may be attached to a first rod 850 that rotates a first gear 860 having a first number of teeth T1. First gear 860 may drive a second gear 862 having a second number of teeth T2. Second gear 862 and third gear 864 may both rotate about a second rod 852. As the second gear 862 rotates, the third gear 864 may rotate by the same amount. Third gear 864 may have a third number of teeth T3 that is different than the second number of teeth T2. Third gear 864 may drive a fourth gear 866 having a fourth number of teeth T4. Fourth gear 866 may rotate about a third rod 854. Third rod 854 may be attached to filter 102 such that any rotation in rod 854 will result in a corresponding rotation (tilt) in filter 102. Helical bimetallic strip 856 and the associated gear train may sometimes be collectively referred to as a filter tilting device or filter tilting structures.

Configured in this way, the compound gear ratio is given by the expression (T1/T2)*(T3/T4). In the example of FIG. 9, T1 is equal to 30, T2 is equal to 9, T3 is equal to 21, and T4 is equal to 7, so the compound gear ratio will be equal to (30/9)*(21/7), which is approximately equal to 10. In other words, fourth gear 866 will make 10 turns for a single turn of the first gear 860. This example in which the compound gear ratio is equal to 10 is merely illustrative. As other examples, the filter tilting device employing a gear train may utilize a compound gear ratio of more than 10, more than one, more than two, more than three, more than four, 5-10, 10-15, 15-20, more than 20, less than 20, less than 10, less than 5, or other suitable range. If desired, the gear train of the filter tilting structures may include two or more gears, three or more gears, four or more gears, 3-10 gear, or any suitable number of gears to provide the proper amount of rotational amplification. The amount of rotation (tilt) caused by such filter tilting device should be designed and calibrated to provide the proper amount of tilt at filter 102 so that its passband is automatically aligned (centered) to the spectral output of the light source at different ambient temperatures.

The various embodiments of the filter tilting device described in connection with FIGS. 6-9 represent passive filter adjustments where a temperature change will result in a corresponding tilting (or un-tilting) of filter 102 without using any active circuitry (e.g., without using a processor or controller that consumes power to actively control the amount of rotation in the passband filter) is merely illustrative. FIG. 10 illustrates another suitable embodiment of a filter tilting device such as device 900 that employs an active filter tilting scheme that uses components that do consume power. As shown in FIG. 10, filter tilting device 900 may include a temperature sensor 902 that controls a mechanical actuator 904. Temperature sensor 902 may be an active temperature sensor that outputs temperature readings (measurements), and mechanical actuator 904 may adjust the tilt (or rotation) of filter 102 based on the temperature measurements. Mechanical actuator 904 may generate a linear displacement that pushes on the second end of filter 102 in the way shown in FIG. 5 or may generate a rotational movement that causes filter 102 to rotate about a rotational axis in the way shown in FIG. 8 or 9.

The amount of movement, displacement, or rotation on filter 102 caused by mechanical actuator 904 may be determined using a lookup table (for example) have different levels of actuation for different temperature sensor readings. For example, at lower ambient temperatures, temperature sensor 902 will output a lower temperature measurement and in response, mechanical actuator 904 will cause filter 102 to tilt (or rotate) at a greater angle with respect to the imaging plane of the image sensor (see, e.g., angle θ of FIG. 4) to shift the filter passband to shorter wavelengths. At higher ambient temperatures, temperature sensor 902 will output a greater temperature reading and in response, mechanical actuator 904 will cause filter 102 to tilt (or rotate) at a smaller angle with respect to the imaging plane of the image sensor to shift the filter passband to longer wavelengths. The amount of displacement/deflection caused by active filter tilting device 900 should be designed and calibrated to provide the proper amount of tilt in filter 102 so that its passband is aligned (centered) to the peak spectral output of the light source at different ambient temperatures.

The foregoing is merely illustrative of the principles of this invention and various modifications can be made by those skilled in the art. The foregoing embodiments may be implemented individually or in any combination.

What is claimed is:

1. An imaging system comprising:
a light source configured to emit light having a spectral response;
an optical sensor configured to receive a reflection of the light off of an external object;
a bandpass filter disposed over the optical sensor and configured to filter light received by the optical sensor; and
a filter tilting device configured to tilt the bandpass filter with respect to the optical sensor such that a passband of the bandpass filter tracks the spectral response of the light source at different temperatures.

2. The imaging system of claim 1 wherein the imaging system is part of a vehicle.

3. The imaging system of claim 1 wherein the light source comprises a laser.

4. The imaging system of claim 1 wherein the light source comprises a light-emitting diode.

5. The imaging system of claim 1 wherein the light source comprises an infrared emitter and wherein the bandpass filter comprises an infrared bandpass filter configured to pass infrared light.

6. The imaging system of claim 1 wherein the filter tilting device is configured to push on an end of the bandpass filter.

7. The imaging system of claim 6 wherein the filter tilting device comprises a bimetallic strip having at least two metal layers with different coefficients of thermal expansion.

8. The imaging system of claim 6 wherein the filter tilting device comprises:
a rod; and
a bimetallic strip having at least two metal layers with different coefficients of thermal expansion and helically wrapped along the rod.

9. The imaging system of claim 8 wherein the filter tilting device further comprises a lead screw coupled to the rod and wherein the lead screw has a screw shaft that pushes on the end of the bandpass filter.

10. The imaging system of claim 1 wherein the filter tilting device comprises:
a rod attached to the filter; and
a helically wrapped bimetallic strip configured to rotate the rod about a rotational axis as temperature changes.

11. The imaging system of claim 1 wherein the filter tilting device comprises:
a rod attached to the filter; and
a helically wrapped bimetallic strip configured to rotate the rod via a gear train as temperature changes.

12. The imaging system of claim 11 wherein the gear train comprises at least two gears having different numbers of teeth.

13. The imaging system of claim 1 wherein the filter tilting device comprises:
a temperature sensor configured to output a temperature reading; and
a mechanical actuator configured to provide a corresponding amount of tilt or rotation for the bandpass filter based on the temperature reading.

14. The imaging system of claim 1 wherein the filter tilting device comprises a passive filter tilting device that does not actively consume power.

15. The imaging system of claim 1 wherein the filter tilting device comprises an active filter tilting device that actively consumes power.

16. A method of operating an imaging system, the method comprising:
using a light source to emit light;
using an optical sensor to receive a reflection of the light from an external object;
using a bandpass filter to filter light arriving at the optical sensor;
tilting the bandpass filter by a first amount relative to the optical sensor at a first ambient temperature; and
tilting the bandpass filter by a second amount, different than the first amount, relative to the optical sensor at a second ambient temperature.

17. The method of claim 16 wherein tilting the bandpass filter by the first amount aligns a passband of the bandpass filter to a first peak spectral output of the light at the first ambient temperature and wherein tilting the bandpass filter by the second amount aligns the passband of the bandpass filter to a second peak spectral output of the light, shifted from the first spectral output, at the second ambient temperature.

18. The method of claim 16 wherein tilting the bandpass filter by the first and second amounts comprises using a bimetallic strip to provide a linear deflection or a rotational movement.

19. The method of claim 16 wherein the optical sensor has an imaging plane, the method further comprising:
increasing an angle of tilt between the bandpass filter and the imaging plane as temperatures decreases; and
decreasing the angle of tilt between the bandpass filter and the imaging plane as temperature increases.

20. The method of claim 16 wherein tilting the bandpass filter by the first and second amounts comprises using a bimetallic strip having materials of different coefficients of thermal expansion to tilt the bandpass filter without actively consuming power.

21. A sensor module comprising:
a housing;
a sensor die within the housing;
a filter disposed over the sensor die within the housing; and
filter adjustment structures configured to tilt or rotate the filter by an amount that varies with temperature, wherein the filter adjustment structures include materials having different coefficients of thermal expansion.
